(19) United States
(12) Patent Application Publication
(10) Pub. No.: US 2018/0121631 A1
(43) Pub. Date: May 3, 2018

(54) SYSTEMS AND METHODS FOR MULTI-PARAMETER AND PERSONALIZED DIETARY RECOMMENDATIONS

(71) Applicant: True Positive Analytics Pvt. Ltd., Mumbai (IN)

(72) Inventors: Pramit Mehta, Mumbai (IN); Khamir Mehta, Mumbai (IN); Rishi Bhojnagarwala, Mumbai (IN); Hiren Shah, Mumbai (IN)

(21) Appl. No.: 15/796,745

(22) Filed: Oct. 27, 2017

(30) Foreign Application Priority Data
Oct. 27, 2016 (IN) 201621032931

(51) Int. Cl. G06F 19/00

(52) U.S. Cl. CPC G06F 19/3475; G06F 19/3481; G06F 19/3431

(57) ABSTRACT

Systems and methods providing personalized dietary recommendations based on a taste quotient, a health quotient, and a satiety quotient. The satiety quotient may be calculated by a satiety parameter configuration engine configured to create a satiety profile for each food item by satiety vectors for the food item and then correlating a second synthesized profile of the user with the satiety profile to determine a score of satiety relevancy for the user with respect to the food item. The health quotient may be calculated by a health parameter configuration engine to create a health profile for each food item by health vectors and then correlating a third synthesized profile of the user with the health profile to determine a score of health relevancy for the user with respect to the food item. A recommendation is then provided based on these three quotients.

### RELATED APPLICATIONS

This application claims priority under 35 U.S.C. § 119 to Indian Application 201621032931, filed Oct. 27, 2016, which is incorporated by reference herein in its entirety.

### BACKGROUND

Improving diet and lifestyle may avoid or manage several diseases, including, for example, obesity, cardiovascular issues, and diabetes. Such lifestyle diseases may be addressed through intervention including improving a typical diet, which may require compromising taste and/or satiety. Diet interventions, especially for weight loss, may focus on restricting caloric intake. Moreover, nutritionists, dieticians, and doctors may advocate intake of food generally perceived to be healthy, including, for example, raw fruits and vegetables, and/or avoiding specific food group like fat, carbohydrates, etc. No single intervention has worked for all users, and many existing and relatively effective plans are based on restrictive measures and do not account for user behavior and the nature of human metabolic systems.

### SUMMARY

Example embodiments include systems and method of providing personalized dietary recommendations based on a taste quotient, a health quotient, and a satiety quotient. Example systems may include a first storage device to store content items pertaining to a food item, a second storage device to store content items pertaining to calorific value of food items of the first storage device, and a third storage device to store content items pertaining to geographic location of food items of the first storage device. An attribute manager may determine and store attribute-related content items pertaining to the food items. Selectors prompt the user to select a food item for consumption and food previously ingested by time, date, and serving size. Though an inputter, the user's details relating to height, weight, age, gender, genomic data, genetic data, body data, etc. A metabolic profiler may read and store a metabolic profile of a user. The taste quotient may be calculated by a taste parameter configuration engine creating a taste profile for each food item by taste vectors and then correlating a first synthesized profile of the user with the taste profile to determine a relevancy score for the user with respect to the food item. The satiety quotient may be calculated by a satiety parameter configuration engine configured to create a satiety profile for each food item by satiety vectors for the food item and then correlating a second synthesized profile of the user with the satiety profile to determine a score of satiety relevancy for the user with respect to the food item. The health quotient may be calculated by a health parameter configuration engine to create a health profile for each food item by health vectors and then correlating a third synthesized profile of the user with the health profile to determine a score of health relevancy for the user with respect to the food item. A recommendation is then provided based on these three quotients.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is a schematic block diagram of an example embodiment dietary recommendation system.

FIG. 2 is a flowchart of an example method of obtaining a taste quotient.

FIG. 3 is a flowchart of an example pairing method.

FIG. 4 is a flowchart of an example method of a providing a content item relating to a food item recommendation.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

It will be understood that, although the terms first, second, etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments or methods. As used herein, the term “and/or” includes all combinations of one or more of the associated listed items. The use of “etc.” is defined as “et cetera” and indicates the inclusion of all other elements belonging to the same group of the preceding items, in any “and/or” combination(s).

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

As used herein, the singular forms “a,” “an,” and “the” are intended to include both the singular and plural forms, unless the language explicitly indicates otherwise. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

The structures and operations discussed below may occur out of the order described and/or noted in the FIGs. For example, two operations and/or FIGs shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

The Inventors have newly recognized that behavioral and complex metabolic aspects may be responsible for failure of intervention into lifestyle diseases. For example, owing largely to unaddressed behavioral and metabolic causes, quick regain of weight often occurs as soon as dietary restrictions are relaxed. Many conventional intervention and dietary plans are not repeatable or objectively defined. Procedure and theory underlying many interventions are subjective and lack repeatability or effectiveness outside tightly controlled conditions. Because they do not account for varying human behaviors and biological responses, the interventions often fail. The Inventors have thus newly recognized a need to convert subjective parameters into an objective science by parameterising the subjective items and defining rules for correlating and mapping these subjective items to attain repeatable objective recommendations that work for different individuals. To overcome these newly-recognized problems as well as others and achieve these advantages, the inventors have developed example embodiments and methods described below to address these and other problems recognized by the Inventors with unique solutions enabled by example embodiments.

The present invention is systems and methods for individualized meal recommendations and evaluation. In contrast to the present invention, the few example embodiments and example methods discussed below illustrate just a subset of the variety of different configurations that can be used as and/or in connection with the present invention.

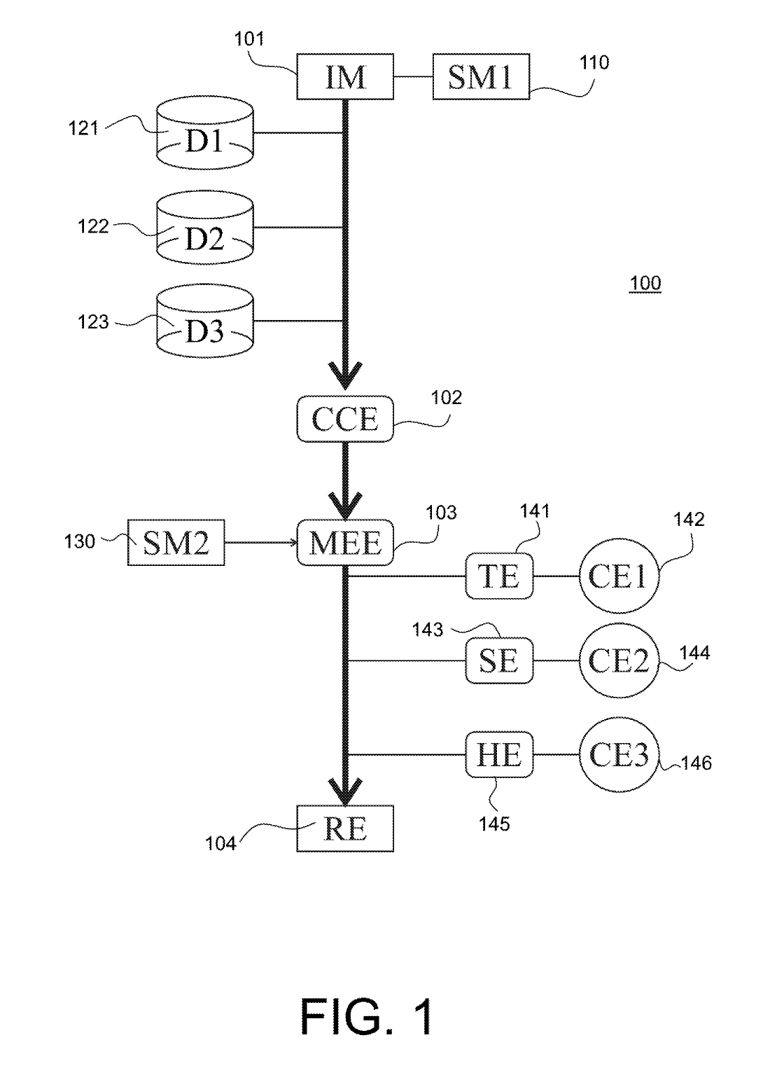

Example embodiments include systems and methods configured to provide users with dietary recommendations that map to fullness parameters, taste parameters, and health parameters. FIG. 1 is a schematic block diagram of an example embodiment dietary recommendation system 100. As shown in FIG. 1, first storage device (D1) 121 is networked with other elements and devices in system 100. First storage device 121 is configured to store content items pertaining to food. First storage 121 may be a relational database for example, storing a set of relationally-defined interconnected items including an identity of a food item, a content item relating to a recipe of the food items, a content item relating to ingredients of the food item, a content item relating to a nutrient of the food item, and a content item relating to a pre-defined parameter of the food item. Content items may pertain to preparation and cooking time, seasonal information (relevant to fresh fruits and certain recipes), geographical preferences, food source (homemade, processed, etc), allergen content, food group, and identity (vegetarian, grains, proteins, etc.). First storage device 121 may include information of typical macronutrients and the calorific content of each of the food items, i.e. fat, protein, and carbohydrates. Important components in context of weight loss, sodium, and sugar will also be collected and stored. Additionally, first storage device 121 may include key micronutrients like vitamins and minerals. This information may be collected and stored for each ingredient, thereby enabling the estimation of any other food item based on its recipe.

Second storage device (D2) 122 is networked with other elements and devices of system 100. For example, second storage device 122 may store content items pertaining to calorific value of food items of first storage device 121. Each food item may be tagged with pertinent calorific values of the food items as well as ingredients of the food item. Third storage device (D3) 123 is networked in system 100 as well. Third storage device 123 may store content items pertaining to geographic location of food items of first storage device 121. Each food item may be tagged with pertinent geographic location(s) of the food items as well as ingredients of the food item. Furthermore, this second storage device may include content items pertaining to cultural attributes of the food items of first storage device 121. Each food item may be tagged with its pertinent cultural attribute(s) as well as ingredients.

An attribute manager may determine and store attributes pertaining to food items stored in first storage device 121. For example, a first selector (SM1) 110 is configured to prompt a user to select at least a choice of food item pertinent to the user. Since each food item may be tagged with attributes forming pertinent content items, these attributes are stored in a relational manner with respect to a user for use by this system and method. These selected food items may be used to retrieve taste attribute content items of a user to map it to recommendations provided to a user.

A user's profile may be synthesized into a first dataset of content items wherein this first synthesized profile includes content items correlative to a user's taste quotient. This first synthesized profile is synthesized by means of a first dynamic GUI generated by a GUI generator wherein a user-specific dynamic GUI is formed to provide a single synthesized view of the user. Each input of the user correlates to a signal comprising a content item fetched from a group of storage devices comprising first storage device 121, second storage device 122, third storage device 123, along with a signal comprising data from attribute manager, and a signal comprising data correlating to a time parameter.

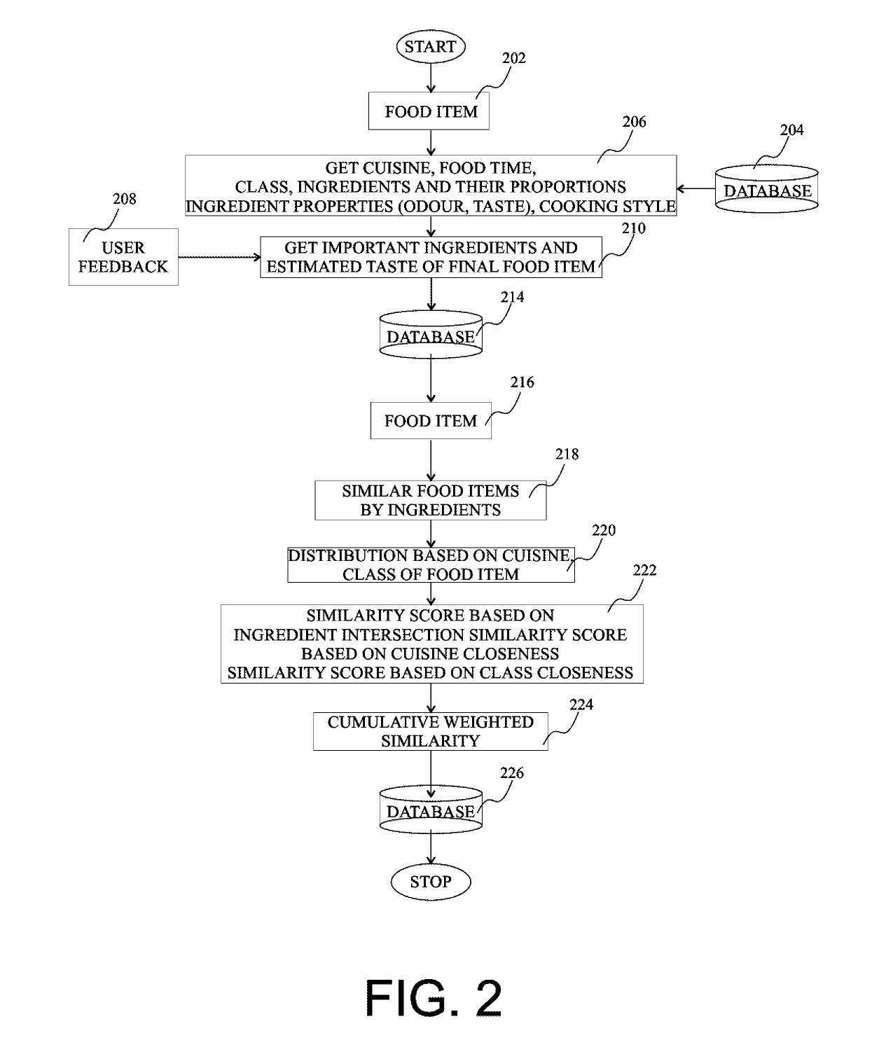

FIG. 2 is a flowchart of an example method of obtaining a taste quotient. As shown in FIG. 2, in 202 a user inputs data relating to a food item that is considered and from a relevant data storage device 204. In 206 relevant content items are obtained, including cuisine, food time, class ingredients and their proportions, ingredient properties (odor, taste), cooking style and the like for the food item. In 208, the user may input feedback regarding recommendations. From such feedback, relevant content items such as important ingredients and estimated taste of final food item may be derived in 210. Based on this data, another storage device 214 is used to output data relating to a food item in 216. In 218 similar food items are correlated and identified by ingredients. Similar food items may also be identified in 220 as distributions based on cuisine, class of food item, and the like. In 222, a similarity score may be calculated based on an ingredient intersection similarity score based on cuisine closeness similarity score based on class closeness. This data may be used to determine a cumulative weighted similarity in 224 usable to output a content item for a corresponding food item recommendation from a data storage device in 226.

As shown in FIG. 1, second selector 130 is configured to prompt a user to select one or more food items that a user has eaten, along with time and date and serving size of the eaten item. This enables the system and method to track user intake and patterns. In this way, second selector 130 may store and record the user's food consumption history. Since each food item is tagged with attributes forming pertinent content items, these attributes may be stored in a relational manner with respect to a user for use by example systems and methods. The selected food items may be used to retrieve satiety attributes of content items for a user to map to recommendations provided to a user. A user's profile is synthesized into a second dataset of content items wherein this second synthesized profile includes content items correlative to a user's satiety quotient. Furthermore, selected food items may be used to retrieve health attribute content items for a user to map to recommendations provided to a user. A user's profile is synthesized into a third dataset of content items correlated to a user's health quotient.

A user's profile may be synthesized into a second dataset of content items wherein this second synthesized profile includes content items correlative to a user's satiety quotient. This second synthesized profile is synthesized by means of a second dynamic GUI generated by a GUI generator wherein a user-specific dynamic GUI is formed to provide a single synthesized view of the user. Each input of the user correlates to a signal comprising a content item fetched from a group of storage devices comprising first storage device 121, second storage device 122, third storage device 123, along with a signal comprising data from attribute manager, and a signal comprising data correlating to a time parameter.

A user's profile is synthesized into a first dataset of content items wherein this third synthesized profile includes content items correlative to a user's health quotient. This third synthesized profile is synthesized by means of a third dynamic GUI generated by a GUI generator wherein a user-specific dynamic GUI is formed to provide a single synthesized view of the user. Each input of the user correlates to a signal comprising a content item fetched from a group of storage devices comprising first storage device 121, second storage device 122, third storage device 123, along with a signal comprising data from attribute manager, and a signal comprising data correlating to a time parameter.

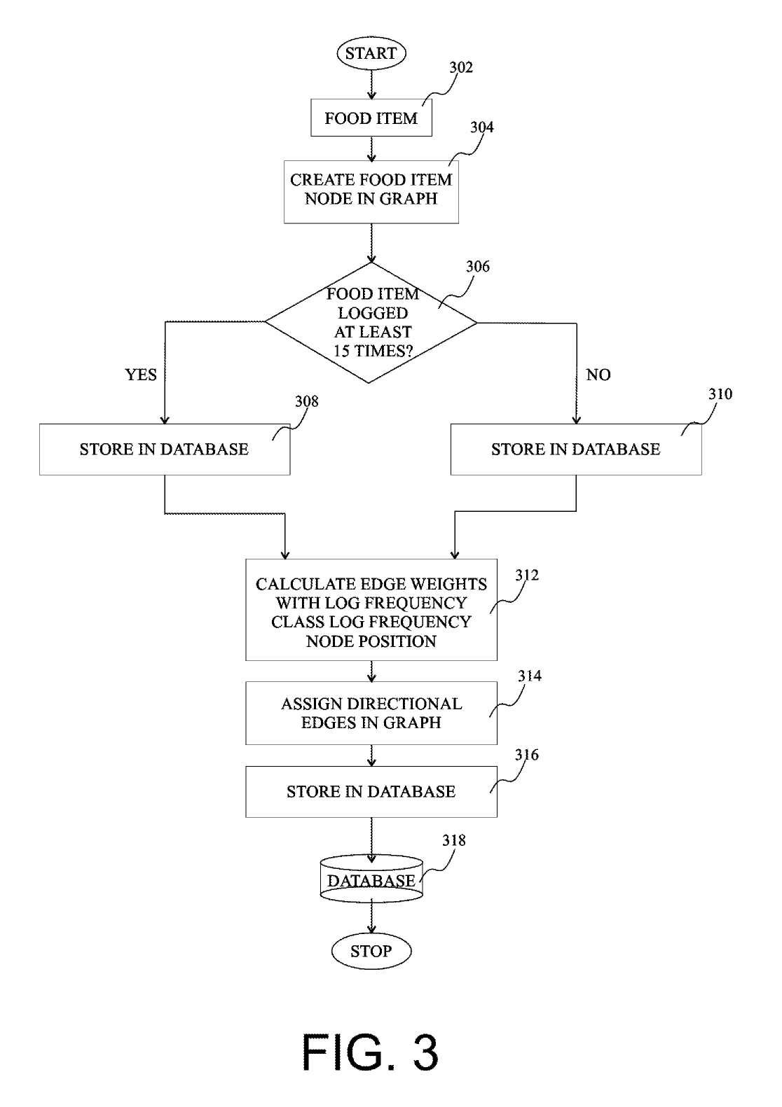

Inputter (IM) 101 is configured to prompt a user to input a user's details relating to at least one of height data, weight data, age data, gender data, location data, ethnicity data, genomic data, genetic data, and the like pertinent body data. FIG. 3 is a flowchart of an example pairing method. As seen in FIG. 3, a user inputs data relating to a food item in 302. Using this input, the food item is mapped in 304 as a node in a graph. If it is determined in 306 that the specific content item relating to a food item is logged more than a pre-defined number of times, then its position node is correlated in 308 with most similar pairings in terms of taste and class. If the specific content item relating to a food item is not logged as determined in 306 more than a threshold number of times, then its position node is based in 310 on terms of class information and taste profile. In either instance, edge weights of the content item are calculated in 312 with log frequency and class log frequency node position. Directional edges may be assigned in 314 in the graph. The resulting graph may be stored in 316 in data storage device 318.

A metabolic profiler may read and store a metabolic profile of a user. This user metabolic profiler enables a user to arrive at calorific targets for individual meals and desired weight gain/loss. A user metabolic profile may be communicably coupled with user-defined calorific targets or system-defined calorific targets to provide pertinent recommendations. Wearables and other such input mechanism may be configured to provide distributed nodes as input mechanisms for recording intake. Metabolic profiles may be captured through these devices. Since each food item can be tagged with attributes forming pertinent content items, these attributes may be stored in a relational manner with respect to a user. Selected food items may be used to retrieve metabolic attribute content items of a user to map to recommendations provided to a user.

Example methods and embodiments may use a linearized form of the model in closed form analytical solution to arrive at a typical calorific requirement for the user based on input data items. As shown in FIG. 1, calorific computation engine (CCE) 102 is configured to receive a user's weight goal to determine an appropriate cut in the calorific intake of the user. Calorific computation engine 102 is configured to compute a staggered, time-defined, goal-defined calorific data per user, per time period, per goal. Feedback over successive time intervals and user inputs may be used to re-define the calorific computation engine based on the feedback.

Meal evaluation engine (MEE) 103 is configured to receive data from second selector 130 to output data relating to a user's ingested meal into pre-defined attribute content items. Meal evaluation engine 103 may evaluate a user's current meal to suggest modifications to the user's meals. Data from first storage device 121, second storage device 122, and third storage device 123 may be used in this evaluation. Activity monitors in wearables and other such input mechanisms may be configured to monitor physical activity of a user and store it in terms of activity data items. This enables the system and method is used to calculate or obtain energy expenditure of the user.

Taste parameter configuration engine (TE) 141 is configured to create a taste profile for each food item. A taste vector mapping engine is configured to map the taste vectors for a taste profile for a food item to provide relevant recommendations from the recommendation engine. Each food item is defined by taste vectors and stored in a taste storage device, each of the taste vectors being correlated to a food item. A plurality of taste vectors for a taste profile for a food item. These taste vectors and correlations are further used to map to recommendations provided to a user.

First correlation engine (CE1) 142, governed by a first rule engine, correlates a first synthesized profile of a user with a taste profile of a food item to determine a score of relevancy of taste for a user with respect to the food item. This taste score is a component of a taste quotient whilst recommending a food item. The food and user taste profile are generated and stored as a vector record in six dimensional taste space referred to as the taste space. Each dimension of this space is an elementary taste ‘Saltiness’, ‘Sweetness’, ‘Sourness’, ‘Saltiness’, ‘Bitterness’, ‘Umami, and ‘Hot’. The value associated with each of these dimension is assumed to lie between 0 and 1, 1 signifying the maximal intensity and 0 being the minimum. The hypercube enclosed by each of this dimension is the taste space, and any individual food item lies within the hypercube. This hypercube then becomes the universal domain within which all food items lie.

Each ‘ingredient’ in a recipe is assigned a level of flavor/taste in each of the six dimensions. This number is assigned based on expertise and experience. For example, the ingredient salt has a value 1 in the dimension of ‘saltiness’ while having a value 0 in all other dimensions. Lemon Juice is assumed to have 0 in all dimensions, but a value of 1 in ‘sourness’. Water can be assumed to have a value 0 in all dimensions. For any other food item, the ingredients taste vectors may be added weighted on the relative contribution in the recipe and the composite taste vector for the food item is computed. Each value in the vector (i.e. contribution in each taste dimension) may be normalized to lie between 0 and 1. For example, lemonade, with ingredients as water (250 grams), lemon juice (20 grams), sugar (10 grams), and salt (2.5 grams). The composite taste vector may be 20*1+0*250+0*10+0*2.5=20/282.5 (=0.07) in sourness, and similarly 10/282.5 (=0.035) in sweetness, and 2.5/282.5 (=0.009) in saltiness. It will have 0 in the ‘Hot’ dimension, since it does not have any ingredient that contributes to that dimension.

The food item may be further characterized by two more attributes, texture and smell. Those additional attributes are also collected and stored with discrete levels and used to characterize the food item. Based on above valuation, example systems and methods can compute the taste vector for any food item in the storage device and also characterize it in form of texture and smell. To generate a user taste profile, a user may log frequently eaten data and liked food data. Each of these items, in the taste dimension constitutes a user taste preference. The unique features of these points in the taste space are represented by the location of individual points. For large datasets, wherein the user log has several items, the features are extracted using hierarchical clustering algorithms, to enable speedy computations of subsequent food item likelihoods.

Satiety parameter configuration engine (SE) 143 is configured to create a satiety profile for each food item. A satiety vector mapping engine is configured to map the satiety vectors for a satiety profile for a food item to provide relevant recommendations from the recommendation engine. Each food item is defined by satiety vectors and stored in a satiety storage device, each of the satiety vectors being correlated to a food item. A plurality of satiety vectors for a satiety profile for a food item. These satiety vectors and correlations are further used to map it to recommendations provided to a user.

The satiety parameter configuration engine invokes a function of mathematical optimization for meal size. Each food item in a meal that is to be recommended is further optimized based on user calorific target. This is accomplished by adding individual calorific values of the content items pertaining to a food items in a meal and scaling them to meet an overall meal target in a simultaneous optimization. In at least one embodiment, the targets are set based on individual macronutrient composition bases (fat, protein, carbohydrates) and also for each meal time (breakfast, lunch, snack, dinner). A feedback mechanism allows the system and method to be self-learning, to recalibrate, to re-estimate, and to refine a user's taste and metabolic profiles to provide better recommendations based on a user's objective.

Food preparation and recipes may have intrinsic variability. The same food item, depending on the preparation, can have widely different nutritional content depending upon the amount and quality of the ingredient used. Additionally, the metric of serving size also varies with the user. To account for this, example systems and methods may refines the food intake term in a metabolic profile model for an individual user by introducing an adjustment factor that can account for this variability in broad terms without going into the tedious details of the specific user recipe and accurately measuring his food servings. The system and method hypothesizes that in time with large enough data, this factor will converge to a user specific value that can be considered a constant.

By gathering the time course of user weight data and estimating the efficiency factor of food intake, this can be achieved. The following mathematical model may describing an individual's body weight as a function of the calorific intake. Body weight typically follows the following equation:

$$\frac{dBW}{dt} + α ( BW - {BW}_{0} ) = ( {\sum }_{i} ( \frac{1}{{τ}_{i} {EI}_{i}} ) - {\sum }_{j} ( \frac{1}{{τ}_{j}} {EE}_{j} ) )$$

where BW=body weight; BW₀=initial body weight; τᵢ=time scale of body weight gain/loss; t=time; EIᵢ=Energy Intake of food of type.

The food types are divided into different subgroups, e.g. at a larger scale, they include the known divisions—fat, carbohydrates, proteins—but they can be further subdivided based on sources, e.g., carbohydrates from sugar, starch, vegetables, dairy, and the like. In this equation, different types of energy intake (food intake) are summed up with a specific weighting (1/τᵢ) that distinguishes each food item based on the above mentioned classification. A mechanistic interpretation of this weighting is the timescale of the metabolism of the food item wherein it is digested and contributes to the body weight. Including this weighting factor is a fundamental mechanism which distinguishes carbohydrates from say cane sugar as against those obtained from eating fresh fruits. Another interpretation of this is the allowance of differences in the metabolism of different type of food groups depending upon its sources.

Finally, this weighting is also specific to each user depending upon his/her own metabolism (which depends again on factors like age, weight, sex, etc). Initially, these weights may be established using averaged benchmarked data for users similar to the individual's demographic attributes. As more specific individual data on users weight and food intake is gathered, we use a standard non-linear regression algorithm to establish and estimate the user specific timescales for each of the food groups, and update the parameters. This model then can be used to get newer predictions on the user's weight loss journey.

The term EEj represents energy expenditure (physical activity). Energy expenditure is also a sum of different activities (just like the energy intake), which user performs, both actively as well as passively. A workout that includes running, cycling, yoga, or the like is an active activity, while routine activities (breathing, working, sitting, sleeping) are considered passive. Like in the energy intake, τⱼ refers to the timescale of contribution of the activity to the user's body weight. It is further customized to reflect the individual user's specific time constant of weight loss/gain. The total term is a collection of all user activities, as per his or her logs in the mobile app and/or inference from connected wearable devices. Each activity can affect the body weight differently and hence is assigned a specific time constant, which is further inferred and estimated for each individual based on collected data. Initially, in absence of the data, an average measure from data of similar users may be used.

Given the measurement of the body weight following the prescribed change in food intake, the system and method can estimate the expected objective achievement as per the calculation above and assuming a particular values of the parameters. Comparing that with the measured body weight from user's logs, the system and method can then make an updated estimate of parameters so that the expected body weight matches with the observed body weight. That estimated parameters can be now used to make a refined metabolic profile of the user which can then be further used to get better calorific targets. Every time a new weight measurement is available, the system and method can make estimate the parameters again. The final value of parameters used for targets is averaged across all measurements, thereby not giving any undue pivot to a particular data point.

Second correlation engine (CE2) 144, governed by a second rule engine, correlates a second synthesized profile of a user with a satiety profile of a food item to determine a score of relevancy of satiety for a user with respect to the food item. This satiety score is a component of a satiety quotient whilst recommending a food item. For relevance, an estimation of likelihood of a potential recommendation of a food item from first storage device 121 may be correlated with respect to user taste profile.

Once the user taste profile is created, the likelihood of any food item to be in accordance with a user's taste preference may be computed by determining the distance of its co-ordinates in the state space to any of the items liked by the user in the corresponding taste profile. Mathematically, it is accomplished by computing the Euclidian distance of the new food item from each of the co-ordinates of the users taste profile, and then using the minimum of that. According to this system and method, it imposes the following condition to estimate the probability of any food item i to be within the users taste preference:

1−pᵢ=min{tⱼ, tᵢ)} where

pᵢ is the probability of user liking the food item I;

t=taste vector for items; and

j=items in the user taste preference coming from historical data and user logs.

Example systems and methods are further configured to incorporate the food items' texture and odor to characterize the user's preferences. Like with the taste space described above, both odor and texture will have their own subspace on which each of the food item would be profiled and stored. The user preferences and history will also be stored accordingly.

Health parameter configuration engine (HE) 148 is configured to create a health profile for each food item. A health vector mapping engine is configured to map the health vectors for a health profile for a food item to provide relevant recommendations from the recommendation engine. Each food item is defined by health vectors and stored in a health storage device, each of the health vectors being correlated to a food item. Several health vectors may make up a health profile for a food item. These health vectors and correlations are further used to map to recommendations provided to a user.

Third correlation engine (CE3) 146, governed by a third rule engine, correlates a third synthesized profile of a user with a health profile of a food item to determine a score of relevancy of health for a user with respect to the food item. This health score is a component of a health quotient whilst recommending a food item.

Recommendation engine (RE) 104 is configured to provide food item output from first storage device 121 based on rules configured by a rule engine. The rule engine receives inputs from first storage device 121, second storage device 122, third storage device 123, first selector 110, second selector 130, inputter 101, metabolic profiler, calorific computation engine 102, meal evaluation engine 103, activity monitors, taste parameter configuration engine 141, first correlation engine 142, satiety parameter configuration engine 143, second correlation engine 144, health parameter configuration engine 145, and third correlation engine 146 to output a food item from first storage device 121. The recommended food item is pertinent to a user in terms of satiety quotient, taste quotient, and health quotient. Recommendation engine 104 functions on output of first correlation engine 142, second correlation engine 144, and third correlation engine 146. In other words, recommendation engine 104 outputs a content item having a cumulative strength corresponding to a health quotient, a taste quotient, and a satiety quotient.

In this way a user may obtain automatic recommendation meals that account for user taste and metabolic profile. First, example system 100 computes the typical food items that can be combined for a meal. The choice of food items is based on a mathematical scheme that weighs the taste and the nutritional aspects along with the user preferences. Second, the meal combination is scaled to meet the calorific targets as per the estimations of the individual's metabolic profile. The typical servings of food groups that should be present in a diet are outlined by nutritional science. Example systems and methods are adapted to combine food items so that the combination should represent each food group adequately (grains, fruits and vegetables, proteins, fats and dairy, etc). This narrows down the items in the combinations based on the user taste profile and other preferences. These final combinations then form the user meal recommendations which are stored in a user specific storage device that is used to pick and recommend meals for the user.

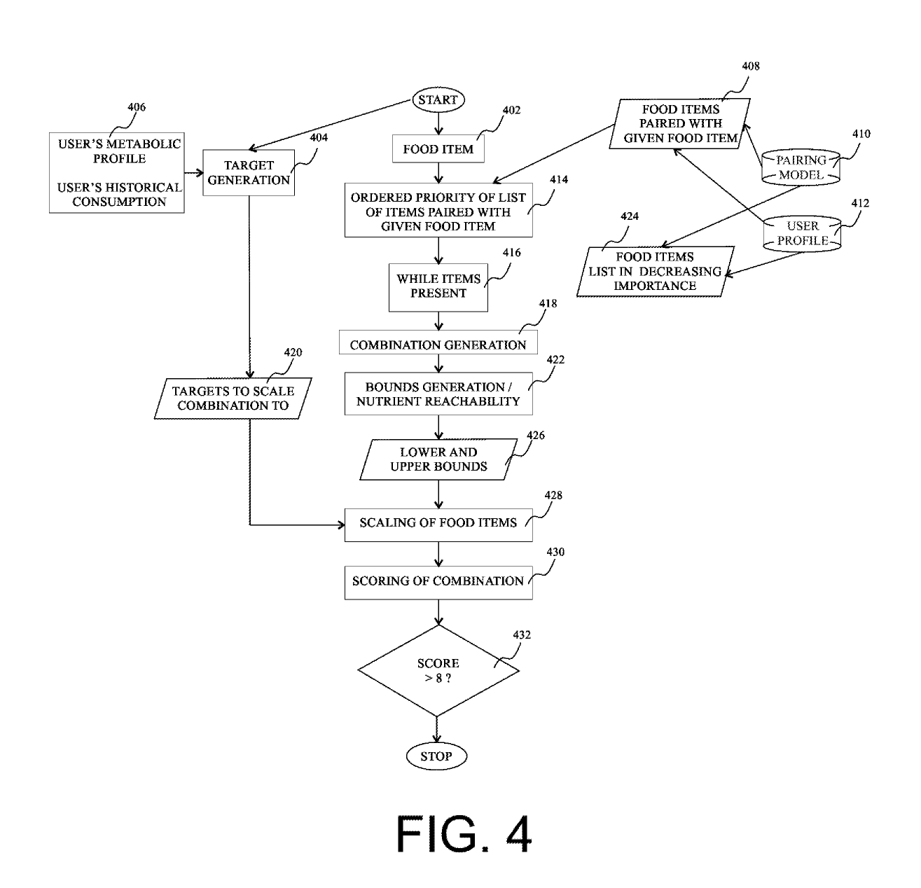

FIG. 4 is a flowchart of an example method of a providing a content item relating to a food item recommendation. In 406, a user's metabolic profile is input along with target 408 to be achieved. In 402, the user inputs data relating to a food item for consideration. Using this input, the food item is paired in 408 with given food items using pairing model 410 from FIG. 3 and a stored user profile 412 is used to generate in 414 an ordered priority of list of items paired with the selected food item. From these items 416, a combination is generated in 418 that allows the system to generate nutrient reachability in 422 for the meal or a set of meals. Data relating to content items corresponding to food items is listed in 424 in order of decreasing importance for the user in correlation with the user's user profile 412 and the system's pairing model 410. Each set of recommendations is classified in 426 in terms of lower and upper bounds with respect to a user's profile and with respect to a user's target. This classification is then used in scaling of content data in 428 corresponding to scaling of food items which is further used in the various scoring engines 430. Simultaneously, content items relating to targets 420 to scale combination are also used in scaling of content data in 428 corresponding to scaling of food items that is further used in the various scoring engines 430. Each score or a cumulative score is checked in 432 against threshold values and then output is generated.

A gamification feature may be provided that can track user's good food habits and allows the user to redeem it for popular healthy activities. Meals may also be optimized. This provides the user with real time optimization of the meal components based on his/her taste and metabolic profile. The user may enters current meal components and use example systems to evaluate it. The system looks for components of the meals in terms of elementary nutritional measures (carbohydrates, proteins, vitamins, minerals, fibers, sugar etc.) and then checks that again the daily targets set based on the user's metabolic profile (and/ or meal plans). If the target is not met, the system makes modifications to the meal items by adding new items/scaling the portions to make the meal achieve the user-specific meal targets.

The user may also build meals. This feature provides the user with recommendations based on specific user-provided ingredient list and also provides the user with possible recipes. The recommendations are based on the user's taste and metabolic profiles, as before.

As seen, example systems and methods may provide personalized recommendations relating to food items. This may not require adherence to strict regimes and also provides personalized recommendations and scores by incorporating a user's tastes and preferences while meeting dietary targets that are supplied by the user and/or computed directly based on available knowledge. Example methods and systems may be implemented on a mobile/web device to compute user taste profiles and estimate the probability of ‘likeability’ of a new food item based on his previous history, learn user's metabolic profile that can adjust the individual diet targets in a dynamic manner, and integrate the user diet targets with the user taste profiles/preferences and physical activity and provide diet recommendations from food storage device that meet the dietary goals. Rank order of the user meals may be provided when queried to provide the user with a real time check on the suitability of the meal items, and also the appropriate portion size. Through example systems and methods, users may build and evaluate meals starting from specific food items/ingredients so as to maximize their health benefits for the user and also the probability of alignment of the meal taste and satiety to user's preferences. Example methods and systems may incorporate the dynamics of blood glucose increase following the food intake and the subsequent lipogenesis to directly address the timing of the food intake and the generation of fat tissue. This model (in form of dynamic differential equations) will be personalized for the user based on the time course of weight changes after a given diet.

Example methods and embodiments thus being described, it will be appreciated by one skilled in the art that example embodiments may be varied through routine experimentation and without further inventive activity. For example, example embodiments have been described with respect to certain types of foods and meals for weigh loss or caloric intake, it is understood that any type of target or user profile, such as sodium limitations, may be used in the same. Variations are not to be regarded as departure from the spirit and scope of the exemplary embodiments, and all such modifications as would be obvious to one skilled in the art are intended to be included within the scope of the following claims.

1-17. (canceled)

18. A method of providing personalized dietary recommendations based on multiple parameters, the method comprising:
receiving a user selection of at least a choice of food item;
prompting the user to select a food item that the user ingested along with a time, a date, and a serving size of the ingestion;
prompting the user to input the user's details relating to at least one of height data, weight data, age data, gender data, location data, ethnicity data, genomic data, genetic data, and pertinent body data;
reading and storing a metabolic profile of the user;
creating a taste profile for each food item, wherein, each food item is defined by taste vectors and stored in a taste-related storage device, each of the taste vectors being correlated to a food item;
correlating a first synthesized profile of the user with a taste profile of a food item to determine a score of relevancy of taste for the user with respect to the food item;
creating a satiety profile for each food item, wherein, each food item is defined by satiety vectors and stored in a satiety-related storage device, each of the satiety vectors being correlated to a food item;
correlating a second synthesized profile of the user with a satiety profile of a food item to determine a score of relevancy of satiety for the user with respect to the food item;
creating a health profile for each food item, wherein, each food item being defined by health vectors and stored in a health-related storage device, each of the health vectors being correlated to a food item;
correlating a third synthesized profile of the user with a health profile of a food item to determine a score of relevancy of health for the user with respect to the food item; and
recommending a food item output from the first storage device based on the first, second, and third synthesized profile for the user.

19. A system, comprising:
a first storage device storing content items of a food item;
a second storage device storing content items of calorific value of the food items;
a third storage device storing content items of geographic location of the food item;
an attribute manager configured to determine and store attribute-related content items pertaining to the food item;
a first selector configured to prompt a user to select a choice of food item pertinent to the user;
a second selector configured to prompt a user to select an ingested food item with time, date, and serving size of ingesting;
an inputter configured to prompt a user to input the user's details relating to at least one of height data, weight data, age data, gender data, location data, ethnicity data, genomic data, genetic data, and pertinent body data, wherein, the inputter includes a wearable configured to provide a distributed node for receiving input;
a metabolic profiler configured to read and store a metabolic profile of the user;
a taste parameter configuration engine configured to create a taste profile for the food item, wherein the food item is defined by taste vectors stored in a taste-related storage device;
a first correlation engine configured to correlate a first synthesized profile of the user with a taste profile of the food item to determine a score of taste relevancy for the user with respect to the food item;
a satiety parameter configuration engine configured to create a satiety profile for the food item, wherein the food item is defined by satiety vectors and stored in a satiety-related storage device;
a second correlation engine configured to correlate a second synthesized profile of the user with a satiety profile of the food item to determine a satiety score for the user with respect to the food item;
a health parameter configuration engine configured to create a health profile for the food item defined by health vectors and stored in a health-related storage device;
a third correlation engine configured to correlate a third synthesized profile of the user with a health profile of the food item to determine a health score for the user with respect to the food item; and
a recommendation engine configured to provide a food item output from the first storage device based on outputs from the first correlation engine, the second correlation engine, and the third correlation engine.

20. The system of claim 19, further comprising:
a calorific computation engine configured to receive the user's weight goal, determine an appropriate cut in the calorific intake of the user, and provide the cut to the first correlation engine, the second correlation engine, and the third correlation engine, wherein the calorific computation engine is further configured to compute calorific data for the user over a time period to meet the goal.

21. The system of claim 19, further comprising:
a meal evaluation engine configured to receive data from the second selection mechanism to output data relating to the ingestion into attribute content items.

22. The system of claim 19, further comprising:
a wearable activity monitoring module configured to monitor physical activity of the user and store the physical activity as activity data items.

23. The system of claim 19, further comprising:
a taste vector mapping engine configured to map the taste vectors to recommendations from the recommendation engine.

24. The system of claim 19, further comprising:
a taste vector mapping engine configured to map the taste vectors to recommendations from the recommendation engine by mapping each food item in a six-dimensional space array, wherein each dimension correlates a taste type with an intensity.

25. The system of claim 19, further comprising:
a taste vector mapping engine configured to map the taste vectors to recommendations from the recommendation engine, wherein the taste vector mapping engine is configured to map each food item in a six-dimensional space array, wherein each dimension correlates a taste type with an intensity, and wherein the taste vectors are weighted and normalized based on ingredients.

26. The system of claim 19, further comprising:
a satiety vector mapping engine configured to map the satiety vectors to recommendations from the recommendation engine.

27. The system of claim 26, wherein the space vector mapping engine is configured to map each food item to a user-specific calorific target based on at least one of food ingredient composition and time of ingestion.

28. The system of claim 27, wherein the satiety quotient correlates to a body weight and a body type.

29. The system of claim 19, further comprising:
a health vector mapping engine configured to map the health vectors to recommendations from the recommendation engine.

30. The system of claim 19, wherein the first storage device is a set of relationally-defined, interconnected devices that include a content item of a food item identity, wherein the content item relates to a recipe, ingredient, and nutrient content of the food item.

31. The system of claim 19, wherein the second storage device is a set of relationally-defined interconnected devices that include a content item of calorific values and ingredients of the food item.

32. The system of claim 19, wherein the third storage device is a set of relationally-defined interconnected devices that include a content item of geographic location, ingredients, and cultural attributes of the food item.

33. The system of claim 19, wherein the inputter is configured to receive user input, wherein the input is correlated with a content item from the first storage device, the second storage device, the third storage device, the attribute manager, and a time parameter.

34. The system of claim 19, wherein the recommendation engine is governed by a rule engine receiving input from the first storage device, the second storage device, the third storage device, the first selection mechanism, the second selection mechanism, the input mechanism, the metabolic profiling mechanism, the calorific computation engine, the meal evaluation engine, the activity monitoring module, the taste parameter configuration engine, the first correlation engine, the satiety parameter configuration engine, the second correlation engine, the health parameter configuration engine, and the third correlation engine to output a content item of the food item, wherein the output has a cumulative strength corresponding to a health quotient, a taste quotient, and a satiety quotient.

35. A computerized health recommendation system, comprising:
a storage device storing a plurality of food items, calorific values of the food items, geographic locations each associated with the food items, and a metabolic profile of a user;
a computer processor configured to,
prompt the user to select a choice of food item,
prompt the user to select an ingested food item with time, date, and serving size of ingesting,
receive input from the user of at least one of height data, weight data, age data, gender data, location data, ethnicity data, genomic data, genetic data, and pertinent body data,
create a taste profile for the chosen food item defined by taste vectors,
correlate a first synthesized profile of the user with the taste profile to determine a taste score for the user with respect to the chosen food item,
create a satiety profile for the chosen food item defined by satiety vectors,
correlate a second synthesized profile of the user with the satiety profile to determine a satiety score for the user with respect to the chosen food item,
create a health profile for the chosen food item defined by health vectors,
correlate the third synthesized profile with the health profile of the chosen food item to determine a health score for the user with respect to the chosen food item, and
recommend a food item output from the storage device based on a match between the taste score, the satiety score, and the health score.

36. The system of claim 35, wherein the computer processor is further configured to map the taste vectors to recommendations from the storage device, map each of the food items in a six-dimensional space array, wherein each dimension correlates a taste type with an intensity, and wherein the taste vectors are weighted and normalized based on ingredients.

37. The system of claim 36, wherein the computer processor is further configured to map the satiety vectors to recommendations from the recommendation engine, and map the health vectors to recommendations from the recommendation engine.
